(19) United States
(12) Patent Application Publication
(10) Pub. No.: US 2025/0290353 A1
(43) Pub. Date: Sep. 18, 2025

(54) FRONT TRUNK SYSTEM

(71) Applicant: Mitsui Kinzoku Act Corporation, Yokohama-shi (JP)

(72) Inventors: Minetaka KATAGAWA, Kanagawa (JP); Kosuke ANDO, Kanagawa (JP)

(73) Assignee: Mitsui Kinzoku Act Corporation, Yokohama-shi (JP)

(21) Appl. No.: 19/076,535

(22) Filed: Mar. 11, 2025

(30) Foreign Application Priority Data
Mar. 13, 2024 (JP) 2024-039327

(51) Int. Cl. E05B 81/06; B60R 5/02; E05B 81/16; E05B 81/34; E05B 81/86; E05B 83/24; E05B 83/26

(52) U.S. Cl. CPC E05B 81/06; B60R 5/02; E05B 81/16; E05B 81/34; E05B 81/86; E05B 83/24; E05B 83/26

(57) ABSTRACT

A front trunk system, including: a latch device; an operation portion provided in the front trunk; and a switching mechanism configured to switch paths that transmitting the operation force input to the operation portion to the latch device, in which when the vehicle is in a first state, the switching mechanism connects the operation portion and the latch device via a first transmission path, allowing the meshing state between a latch and a primary pawl and a meshing state between the latch and a secondary pawl to be released by the operation force input to the operation portion, and when the vehicle is in a second state, the switching mechanism connects the operation portion and the latch device via the second transmission path, allowing the meshing state between the latch and the primary pawl to be released by the operation force input to the operation portion.

### CROSS REFERENCE TO RELATED APPLICATIONS

This application claims priority to Japanese Patent Application No. 2024-039327 filed on Mar. 13, 2024, the content of which is incorporated herein by reference.

### TECHNICAL FIELD

The present disclosure relates to a front trunk system.

### BACKGROUND ART

This section provides background information related to front trunk systems and is not necessarily prior art to the front trunk system of the present disclosure. In some vehicles such as an electric automatic vehicle and a rear engine automatic vehicle in which an engine is mounted behind a vehicle body, a front of the vehicle body is used as a front trunk (also referred to as a frunk). A front hood that opens and closes the frunk is appropriately locked by a latch device. For example, Patent Literature 1 discloses a latch device including a ratchet that engages with a striker provided at a front hood, and a primary pawl and a secondary pawl that can mesh with the ratchet.

In U.S. Pat. No. 11,414,904B, by an input to a switch or a button provided in a frunk, an unlocking actuator drives to unlock the latch device, and an engine hood is configured to be opened, and thus a person trapped inside the frunk can open the engine hood by himself/herself.

In U.S. Pat. No. 11,414,904B, the latch device is configured to switch, depending on a speed of a vehicle, between a normal mode in which both a meshing state between a primary pawl and the ratchet and a meshing state between a secondary pawl and the ratchet can be released, and a safety mode in which only the meshing state between the primary pawl and the ratchet can be released. Specifically, the mode is switched by driving a mode switching actuator in response to the speed of the vehicle to move a coupling lever provided between the primary pawl and the secondary pawl.

### SUMMARY OF INVENTION

According to an aspect of the present disclosure, there is provided a front trunk system, including:
a latch device configured to engage with a striker provided at a front hood for covering a front trunk of a vehicle;
an operation portion provided in the front trunk and configured to transmit an operation force input thereto to the latch device via a first transmission path or a second transmission path; and
a switching mechanism configured to switch paths for transmitting the operation force input to the operation portion to the latch device based on a state of the vehicle, in which
the latch device includes:
   a latch configured to engage with the striker when the front hood is in a closed state and be biased by a biasing member in a direction to disengage from the striker;
   a primary pawl configured to mesh with the latch when the latch engaging with the striker is disposed at a predetermined primary latch position to maintain the front hood at a fully closed position; and
   a secondary pawl configured to mesh with the latch when the latch released from a meshing state with the primary pawl is disposed at a predetermined secondary latch position to maintain the front hood at a half-engaged position,
when the vehicle is in a first state including a stopped state, the switching mechanism connects the operation portion and the latch device via the first transmission path, allowing the meshing state between the latch and the primary pawl and a meshing state between the latch and the secondary pawl to be released by the operation force input to the operation portion, and
when the vehicle is in a second state including a traveling state, the switching mechanism connects the operation portion and the latch device via the second transmission path, allowing the meshing state between the latch and the primary pawl to be released by the operation force input to the operation portion.

### BRIEF DESCRIPTION OF DRAWINGS

FIG. 1 is a side view of a vehicle to which a front trunk system according to an embodiment of the present disclosure is applied, and is a diagram showing a state where a front hood is at a fully open position.

FIG. 2 is a perspective view of a latch device as viewed from a base plate side.

FIG. 3 is a perspective view of the latch device as viewed from a case side.

FIG. 4 is an exploded perspective view of a housing member.

FIG. 5 is a diagram showing an internal configuration of the latch device as seen from the case side.

FIG. 6 is a diagram showing an actuator unit accommodated in an actuator housing.

FIG. 7 is a block diagram showing a control system of the latch device.

FIG. 8 is a diagram sequentially showing an operation of the latch device when a closing operation of the front hood is performed.

FIG. 9 is a diagram sequentially showing the operation of the latch device when an electric motor drives to move the front hood from a fully closed position to a fully open position.

FIG. 10 is a diagram sequentially showing the operation of the latch device when an operation force input to an in-vehicle-cabin operation portion is transmitted to an emergency lever.

FIG. 11 is a diagram sequentially showing the operation of the latch device when the operation force input to an in-frunk operation portion is transmitted to a primary pawl.

FIG. 12 is a schematic diagram showing a front trunk system in which a first transmission path is set by a switching mechanism.

FIG. 13 is a schematic diagram showing a front trunk system in which a second transmission path is set by a switching mechanism.

FIG. 14 is a schematic diagram showing a front trunk system without the switching mechanism.

### DESCRIPTION OF EMBODIMENTS

Hereinafter, a front trunk system according to an embodiment of the present disclosure will be described in detail with reference to the drawings.

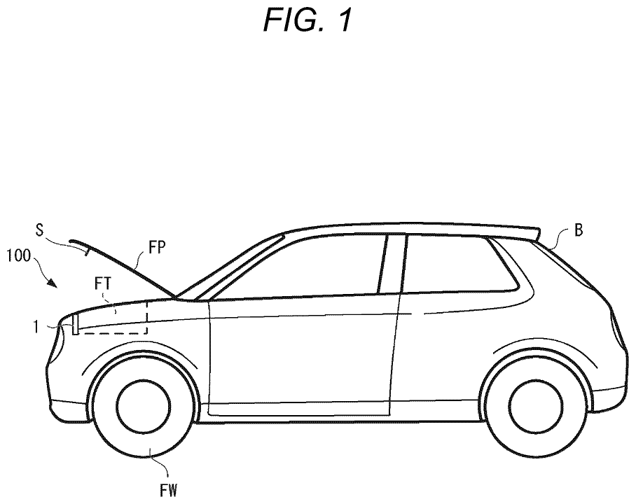

As shown in FIG. 1, a front trunk system 100 according to an embodiment of the present disclosure is applied to a four-wheel automatic vehicle such as an electric automatic vehicle including a front trunk (hereinafter, referred to as a frunk FT) between left and right front wheels FW in front of a vehicle body B. In the following description, for the sake of convenience, each direction is specified in a posture of being mounted on the vehicle body B, and a front side of a vehicle is shown as Fr, a rear side thereof is shown as Rr, a right side thereof is shown as R, a left side thereof is shown as L, an upper side thereof is shown as U, and a lower side thereof is shown as D in the drawings.

### [Overall Configuration of Latch Device]

First, a latch device 1 included in the front trunk system 100 will be described.

The latch device 1 performs opening and closing control of a front hood FP that opens and closes an upper opening of the frunk FT. In the example shown in FIG. 1, the front hood FP is at a fully open position. In the present embodiment, a striker S is provided at a lower portion of a front edge of the front hood FP. The latch device 1 performs control such that the front hood FP is maintained in a closed state or the frunk FT is opened with respect to the vehicle body B by switching between a state of engaging with the striker S and a state of releasing the engagement.

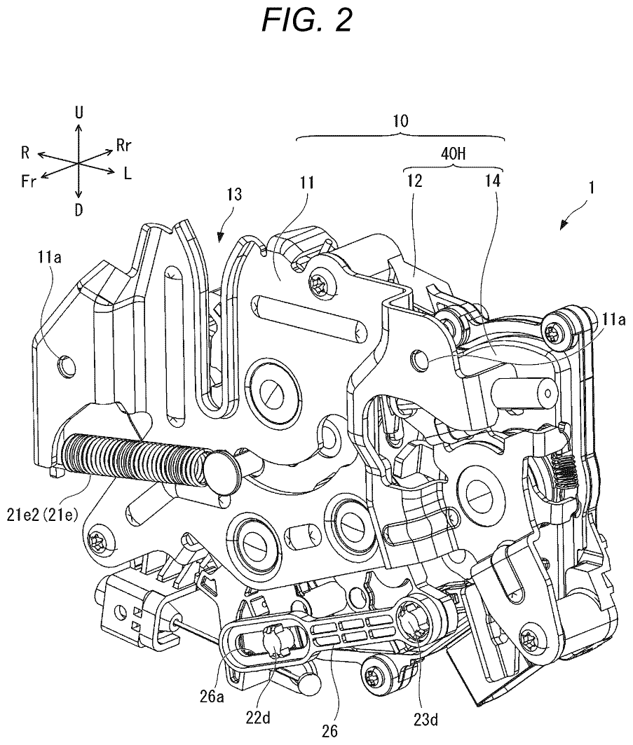

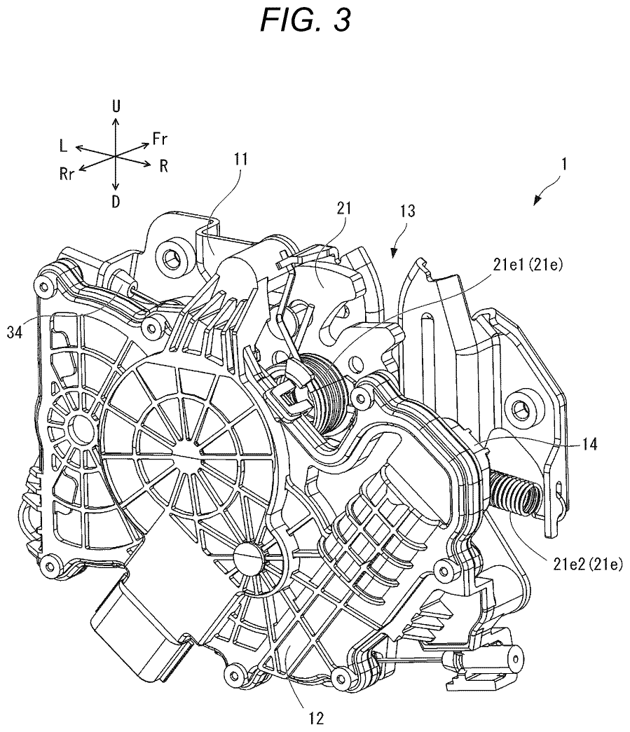

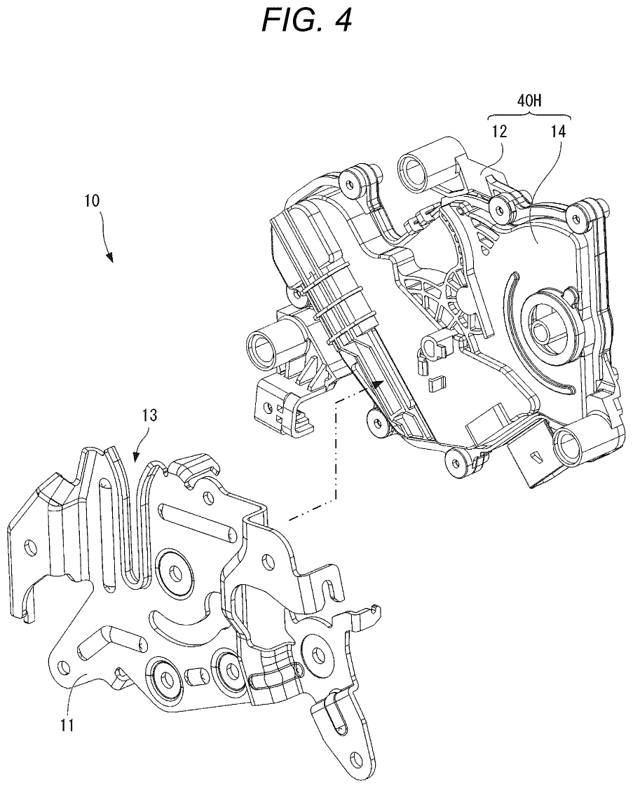

As shown in FIGS. 2 to 6, the latch device 1 includes a housing member 10, a latch 21, a primary pawl 22, a secondary pawl 23, an emergency lever 24, an open lever 35, and an actuator unit 40. The housing member 10 includes a base plate 11, a case 12, and a cover 14. The case 12 accommodates the actuator unit 40 and is covered with the cover 14. The case 12 and the cover 14 form an actuator housing 40H that accommodates the actuator unit 40. The base plate 11 has a plate shape formed of steel. The base plate 11 is provided to face the cover 14 and is fixed to the case 12. The latch 21, the primary pawl 22, the secondary pawl 23, the emergency lever 24, and the open lever 35 are disposed between the base plate 11 and the cover 14. In the base plate 11, a striker entrance groove 13 is formed on one side of an upper portion. The striker entrance groove 13 is a notch into which the striker S enters when the front hood FP is closed with respect to the frunk FT, and is formed to extend along an up-down direction and open at an upper edge of the base plate 11. A dimension of the striker entrance groove 13 is formed to a length that allows the front hood FP to be disposed at a fully closed position with respect to the frunk FT.

When the latch device 1 is attached to the vehicle body B, the base plate 11 is disposed on the front side of the vehicle, and the actuator housing 40H is disposed on the rear side of the vehicle. The base plate 11 is provided with a plurality of vehicle body attachment portions 11a at both left and right end portions, and is attached to the vehicle body B via fastening members such as bolts. Since the base plate 11 is disposed on the front side of the vehicle, an ease of assembly and an ease of attachment to the vehicle body B of a cable described later are improved. When a load collides with the latch device 1 when being loaded into the frunk FT, since the load collides with the base plate 11 first, the actuator unit 40 accommodated in the actuator housing 40H is protected. The latch device 1 thus attached to the vehicle body B can stably operate for a long time.

The latch 21, the primary pawl 22, the secondary pawl 23, and the emergency lever 24 are supported by the base plate 11 via respective support shafts, and can rotate about axes parallel to each other. In the shown example, the support shaft (hereinafter, referred to as a latch shaft 21a) of the latch 21 is provided on a side of the striker entrance groove 13. The support shaft of the primary pawl 22 (hereinafter, referred to as a primary shaft 22a) is provided below the latch shaft 21a around the latch 21, and the support shaft of the secondary pawl 23 (hereinafter, referred to as a secondary shaft 23a) is provided between the latch shaft 21a and the primary shaft 22a around the latch 21. A support shaft of the emergency lever 24 (hereinafter, referred to as an emergency support shaft 24a) is provided at a position farther from the latch 21 than the secondary shaft 23a.

The latch 21 engages with the striker S, and has a striker abutting portion 21b and a hook portion 21c at an outer peripheral portion thereof. The striker abutting portion 21b and the hook portion 21c extend from the latch shaft 21a in a radial direction, can be arranged to cross the striker entrance groove 13 of the base plate 11, and adjacent to each other with an accommodation groove 21d capable of accommodating the striker S therebetween.

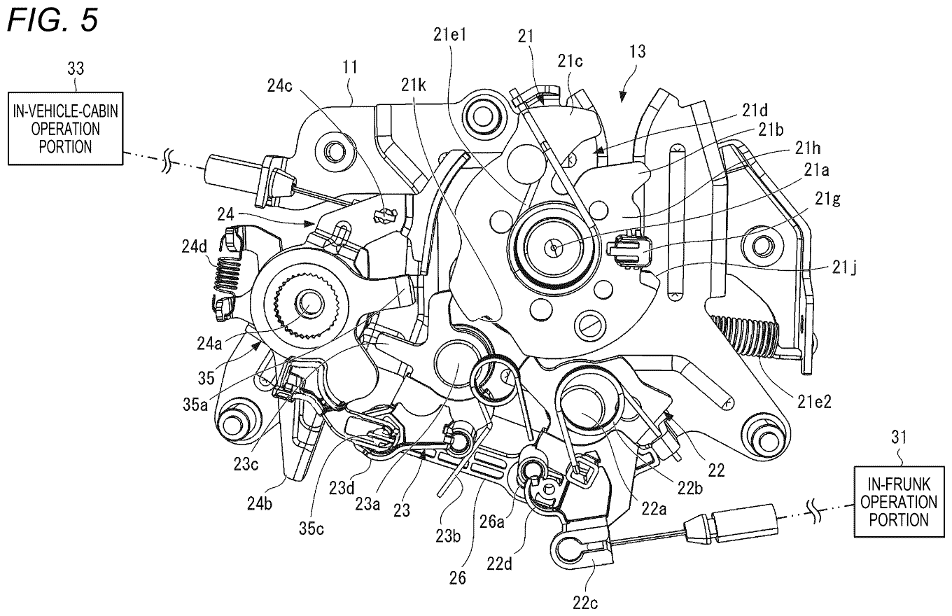

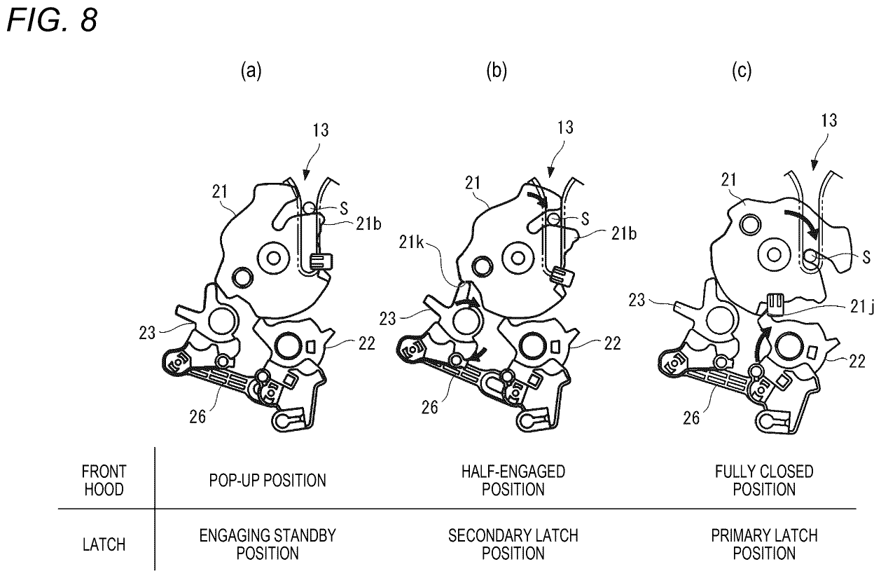

A latch spring 21e including a first latch spring 21e1 which is a torsion coil spring and a second latch spring 21e2 which is a tension coil spring is provided between the latch 21 and the base plate 11. The latch 21 is biased in a direction (counterclockwise direction in FIG. 5. Hereinafter, this direction is also referred to as a release direction) to constantly disengage from the striker S to return to a predetermined engaging standby position by a biasing force of the latch spring 21e provided between the latch 21 and the base plate 11. The engaging standby position refers to a state where the hook portion 21c is retracted laterally with respect to the striker entrance groove 13, the striker abutting portion 21b is disposed at a position crossing the striker entrance groove 13, and an opening of the accommodation groove 21d is aligned with the striker entrance groove 13. Therefore, in the engaging standby position, when the front hood FP is closed, the striker S can enter the striker entrance groove 13. When the front hood FP moves in a closing direction from the fully open position (see FIG. 1), the striker S entering the striker entrance groove 13 abuts against the striker abutting portion 21b, and the front hood is disposed at a pop-up position (see (a) of FIG. 8). When the front hood FP is further moved in the closing direction from the pop-up position, the latch 21 is rotated in a direction (clockwise direction in FIG. 5) to engage with the striker S against the biasing force of the latch spring 21e, and the hook portion 21c is arranged across an opening end portion side of the striker entrance groove 13 while the striker S is accommodated in the accommodation groove 21d.

The latch 21 is also provided with a latch detection magnet 21g. A primary latch position of the latch 21 is a position where the hook portion 21c is arranged across the striker entrance groove 13 while the accommodation groove 21d of the latch 21 is positioned below the striker entrance groove 13. The latch detection magnet 21g detects a rotation state of the latch 21 by a latch sensor 51 described later.

The primary pawl 22 and the secondary pawl 23 mesh with the latch 21 to prevent the latch 21 from rotating in the release direction against the biasing force of the latch spring 21e and stop at desired positions.

More specifically, when the latch 21 is disposed at the primary latch position, the primary pawl 22 meshes with a primary meshing portion 21j of the latch 21 to prevent the latch 21 from rotating in the release direction. A primary spring 22b that constantly biases the primary pawl 22 in a direction to mesh with the latch 21 (hereinafter, also referred to as a meshing direction) is provided between the primary pawl 22 and the base plate 11.

The primary pawl 22 is provided with a frunk cable connection portion 22c. The frunk cable connection portion 22c extends in the radial direction and extends to a position where an extending end portion exceeds the base plate 11. An operation force input to the in-frunk operation portion 31 is input to the frunk cable connection portion 22c via a cable.

The in-frunk operation portion 31 is an operation portion that can be manually operated from the inside of the frunk FT when the front hood FP is in the closed state, and is implemented by a handle, a lever, or the like connected to the latch device 1 via a cable. The operation force input to the in-frunk operation portion 31 is mechanically transmitted to the latch device 1 as a pulling force via the cable. More specifically, when the in-frunk operation portion 31 is operated, the operation force input to the in-frunk operation portion 31 is transmitted via the cable to the frunk cable connection portion 22c of the primary pawl 22, and the primary pawl 22 rotates in a direction to release the meshing state with the latch 21 against a biasing force of the primary spring 22b.

The secondary pawl 23 prevents the latch 21 from rotating in the release direction by meshing with a secondary meshing portion 21k of the latch 21 when the hook portion 21c is arranged across the striker entrance groove 13 (secondary latch position of the latch 21) while the accommodation groove 21d of the latch 21 is positioned above the striker entrance groove 13.

When the latch 21 is disposed at the primary latch position in a state where the striker S is accommodated in the accommodation groove 21d, the front hood FP is disposed at the fully closed position with respect to the frunk FT (see (c) of FIG. 8), and when the latch 21 is disposed at the secondary latch position in the state where the striker S is accommodated in the accommodation groove 21d, the front hood FP is disposed at a half-engaged position that is a position where the front hood FP is slightly opened with respect to the frunk FT (see (b) of FIG. 8).

A secondary spring 23b that constantly biases the secondary pawl 23 in the meshing direction is provided between the secondary pawl 23 and the base plate 11. The secondary pawl 23 is provided with an actuator input portion 23c. The actuator input portion 23c abuts against the open lever 35 when the open lever 35 rotates in the release direction (clockwise direction in FIG. 5), and rotates the secondary pawl 23 in a direction to release the meshing state with the latch 21 against a biasing force of the secondary spring 23b.

The primary pawl 22 and the secondary pawl 23 are coupled via a link bar 26. In the shown example, one end portion of the link bar 26 is rotatably pivoted by a lever link portion 23d of the secondary pawl 23, and the other end portion of the link bar 26 is rotatably pivoted by the lever link portion 22d of the primary pawl 22 via a long hole 26a. The lever link portion 23d of the secondary pawl 23 protrudes outward from an outer peripheral surface of the secondary pawl 23, and the lever link portion 22d of the primary pawl 22 protrudes outward from an outer peripheral surface of the primary pawl 22.

When the secondary pawl 23 rotates in the direction to release the meshing state with the latch 21, the link bar 26 interlocks the primary pawl 22 in the direction to release the meshing state with the latch 21. On the other hand, when the primary pawl 22 rotates in the direction to release the meshing state with the latch 21, the link bar 26 causes the secondary pawl 23 to maintain the meshing state with the latch 21. In more detail, when the primary pawl 22 rotates in the direction to release the meshing state with the latch 21, the link bar 26 does not interlock the secondary pawl 23 with the movement of the lever link portion 22d along the long hole 26a. In this case, the primary pawl 22 rotates independently of the secondary pawl 23, and the secondary pawl 23 is maintained in the meshing state with the latch 21.

The emergency lever 24 includes a pawl pressing portion 24b and a cable connection portion 24c. The pawl pressing portion 24b and the cable connection portion 24c extend in the radial direction from the emergency support shaft 24a. A lever spring 24d for biasing the emergency lever 24 in the clockwise direction in FIG. 5 and causing the emergency lever 24 to be disposed at a predetermined operation standby position is provided between the emergency lever 24 and the base plate 11. The pawl pressing portion 24b is arranged to be separated from the lever link portion 23d of the secondary pawl 23 abutting against the outer peripheral surface of the latch 21 when the emergency lever 24 is disposed at the operation standby position, and rotates the secondary pawl 23 in the release direction by abutting against the lever link portion 23d when the emergency lever 24 rotates in the counterclockwise direction in FIG. 5 against the biasing force of the lever spring 24d.

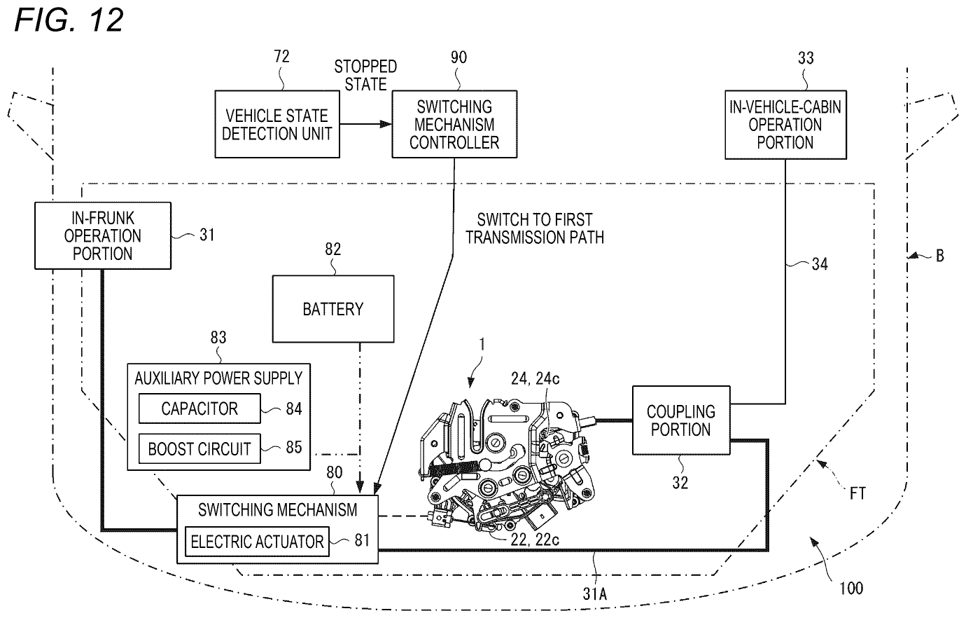

The operation force input to the in-vehicle-cabin operation portion 33 is input to the cable connection portion 24c via a vehicle cabin side transmission path 34 (see FIGS. 12 to 14 or the like) implemented by a cable or the like. The in-vehicle-cabin operation portion 33 is an operation portion provided in a vehicle cabin at a position where the operation is disabled in a state where the vehicle is traveling, for example, on a back side of a foot of a driver seat, and is implemented by a handle, a lever, or the like connected to the latch device 1 via the cable. The operation force input to the in-vehicle-cabin operation portion 33 is mechanically transmitted to the latch device 1 as a pulling force via the cable. More specifically, when the in-vehicle-cabin operation portion 33 is operated, the operation force input to the in-vehicle-cabin operation portion 33 is transmitted via the cable to the pawl pressing portion 24b of the emergency lever 24, and the pawl pressing portion 24b causes the secondary pawl 23 to rotate in the direction to release the meshing state with the latch 21 against the biasing force of the secondary spring 23b.

The open lever 35 is fixed to a boss portion 47a of a sector gear 47 described later, and rotates integrally with the sector gear 47, and thus operates by drive of an electric motor 41.

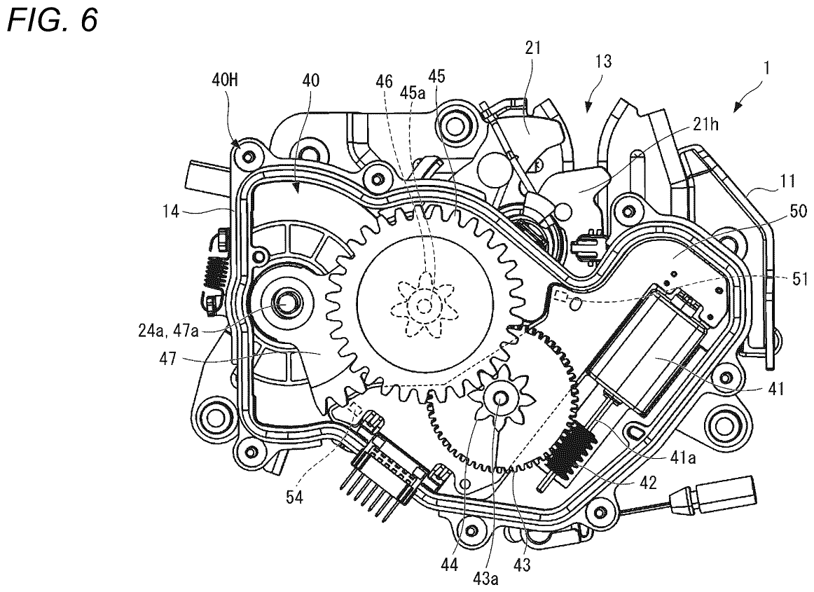

As shown in FIG. 6, the actuator housing 40H is provided with the actuator unit 40 and a circuit board 50.

The actuator unit 40 includes the electric motor 41 capable of rotating forward and backward, and a speed reduction mechanism that reduces a speed of the drive of the electric motor 41 and transmits the drive to the open lever 35. The speed reduction mechanism includes a worm gear 42 provided on an output shaft 41a of the electric motor 41, a first gear (worm wheel) 43 that meshes with the worm gear 42, a third gear 45 that meshes with a second gear 44 provided integrally with the first gear 43, and the sector gear 47 that meshes with a fourth gear 46 provided integrally with the third gear 45. The first gear 43 and the third gear 45 are rotatably supported by the actuator housing 40H via individual support shafts 43a and 45a parallel to the latch shaft 21a. The electric motor 41 is disposed at a portion on an outer peripheral side of the latch 21, and the first gear 43 and the third gear 45 are disposed at positions overlapping a cover facing surface 21h of the latch 21. The sector gear 47 is rotatably supported by the actuator housing 40H via the cylindrical boss portion 47a provided at a center portion. The boss portion (output portion) 47a of the sector gear 47 is provided at a portion on the outer peripheral side of the latch 21 to coincide with the emergency support shaft 24a.

Referring back to FIG. 5, the open lever 35 is fixed to the boss portion 47a of the sector gear 47 and rotates integrally with the sector gear 47, and thus has a pressing lever portion 35a. The pressing lever portion 35a extends in the radial direction from a rotation axis of the open lever 35, and an extending edge portion thereof is bent toward the base plate 11. When the open lever 35 is disposed at a predetermined neutral position, the pressing lever portion 35a is positioned above the actuator input portion 23c provided in the secondary pawl 23. When the electric motor 41 rotates in an open direction from the above neutral position, the open lever 35 rotates in the release direction (clockwise direction in FIG. 5), and causes the secondary pawl 23 to rotate in the direction to release the meshing state with the latch 21 via the actuator input portion 23c.

The open lever 35 is provided with an open lever detection magnet 35c for detecting a position of the open lever 35. The circuit board 50 is provided with a motor neutral sensor 54 for detecting whether the open lever 35 is at the neutral position by detecting the open lever detection magnet 35c.

The circuit board 50 is, for example, a printed circuit board, and is disposed inside the actuator housing 40H. On the circuit board 50, a processing device such as a central processing unit (CPU) or hardware such as an integrated circuit (IC) is mounted constituting a latch device controller 70 described later.

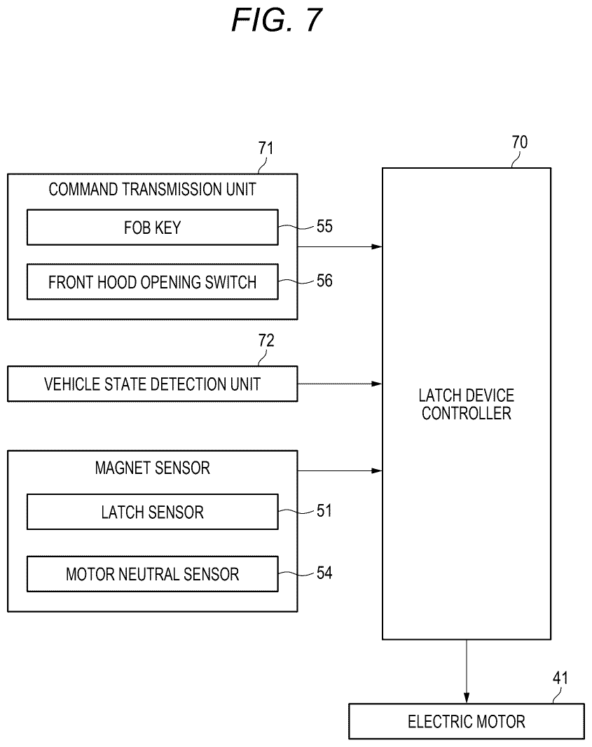

FIG. 7 shows a control system of the latch device 1. When an output signal is supplied from a command transmission unit 71, a vehicle state detection unit 72, the latch sensor 51, and the motor neutral sensor 54, the latch device controller 70 controls the drive of the electric motor 41 in accordance with programs and data stored in a memory. The latch device controller 70 may be implemented, for example, by causing a processing device such as a CPU to execute a program, that is, implemented by software, by hardware such as an IC, or by a combination of software and hardware.

The command transmission unit 71 is for outputting an open command to the latch device controller 70 when the frunk FT is opened, and includes, for example, a frequency operated button (FOB) key 55 possessed by an owner of the vehicle, and a front hood opening switch 56 provided in the vehicle cabin.

The vehicle state detection unit 72 detects at least one of a speed of the vehicle or a gear position of the vehicle. The latch device controller 70 determines the state of the vehicle (for example, whether the vehicle is in a traveling state or a stopped state) based on the detection result of the vehicle state detection unit 72, and controls the drive of the electric motor 41.

### [Operation of Latch Device]

An operation of the latch device 1 will be described in detail.

### (Closing Operation of Front Hood FP)

First, the operation of the latch device 1 when a closing operation of the front hood FP will be described with reference to (a) to (c) of FIG. 8. Note that the open lever 35 is not shown.

When the front hood FP is disposed at the pop-up position, as shown in (a) of FIG. 8, the latch 21 is positioned at the engaging standby position by the latch spring 21e, and the open lever 35 is disposed at the neutral position. In this case, as described above, the primary pawl 22 and the secondary pawl 23 are biased in the meshing direction by the primary spring 22b and the secondary spring 23b, respectively, in a state of abutting against the outer peripheral surface of the latch 21.

When the front hood FP is operated to close the opening of the frunk FT while the vehicle is stopped, as shown in (b) of FIG. 8, the striker S enters the striker entrance groove 13, and the secondary pawl 23 meshes with the secondary meshing portion 21k of the latch 21 to prevent the latch 21 from moving in the release direction, and the latch 21 is disposed at the secondary latch position. As a result, even when the operation force to the front hood FP is removed, the front hood FP is maintained at the half-engaged position where the front hood FP is slightly opened with respect to the frunk FT.

When the front hood FP is further moved in the closing direction, the latch 21 rotates in the meshing direction against the biasing force of the latch spring 21e, and as shown in (c) of FIG. 8, the front hood FP reaches the fully closed position where the opening of the frunk FT is completely closed. In this case, the primary pawl 22 meshes with the primary meshing portion 21j of the latch 21 to prevent the latch 21 from moving in the release direction, and the latch 21 is disposed at the primary latch position. As a result, the front hood FP is maintained at the fully closed position where the frunk FT is closed.

### (Open Operation of Front Hood FP)

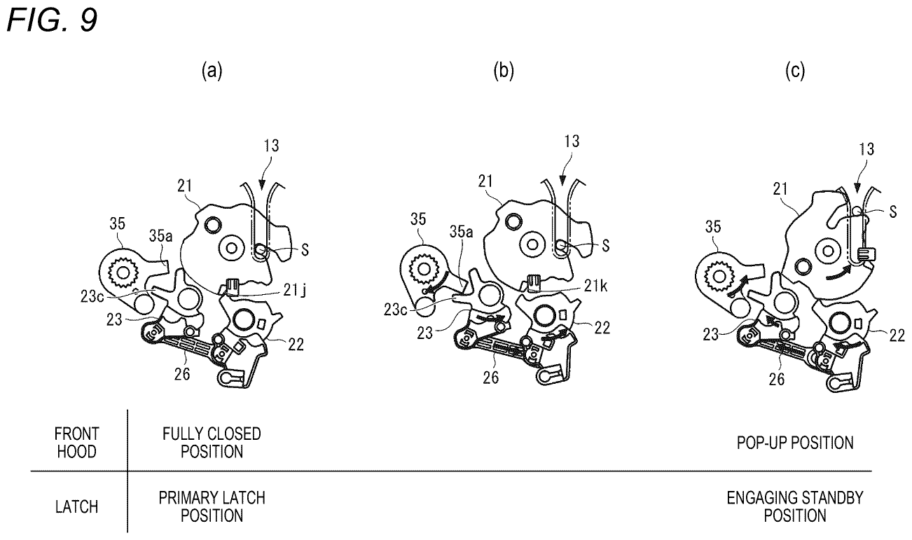

(a) to (c) of FIG. 9 are diagrams sequentially showing the operation of the latch device 1 when the open command is output from the command transmission unit 71 (FOB key 55 or front hood opening switch 56).

As shown in (a) of FIG. 9, when the command transmission unit 71 is operated while the latch 21 engaging with the striker S is at the primary latch position, the latch device controller 70 detecting that the open command is supplied performs an opening process, and determines whether the vehicle is in a first state (details will be described later) including the stopped state based on the detection result of the vehicle state detection unit 72. If the vehicle is in the first state, the latch device controller 70 drives the electric motor 41 in the open direction.

As shown in (b) of FIG. 9, when the electric motor 41 is driven in the open direction, the open lever 35 rotates in the release direction, the secondary pawl 23 rotates in the direction to release the meshing state with the latch 21, the rotation of the secondary pawl 23 is transmitted to the primary pawl 22 via the link bar 26, and the primary pawl 22 also rotates in the direction to release the meshing state with the primary meshing portion 21j of the latch 21.

As a result, as shown in (c) of FIG. 9, the meshing state between the primary pawl 22 and the latch 21 and the meshing state between the latch 21 and the secondary pawl 23 are released, the latch 21 rotates to the engaging standby position by the biasing force of the latch spring 21e, the front hood FP is lifted to the pop-up position, and movement to the fully open position is possible. As described above, when the command transmission unit 71 is operated only once, the front hood FP can be opened to open the frunk FT, and the load can be easily taken in and out of the frunk FT. After the latch 21 rotates to the engaging standby position, the open lever 35 is returned to the neutral position by the drive of the electric motor 41.

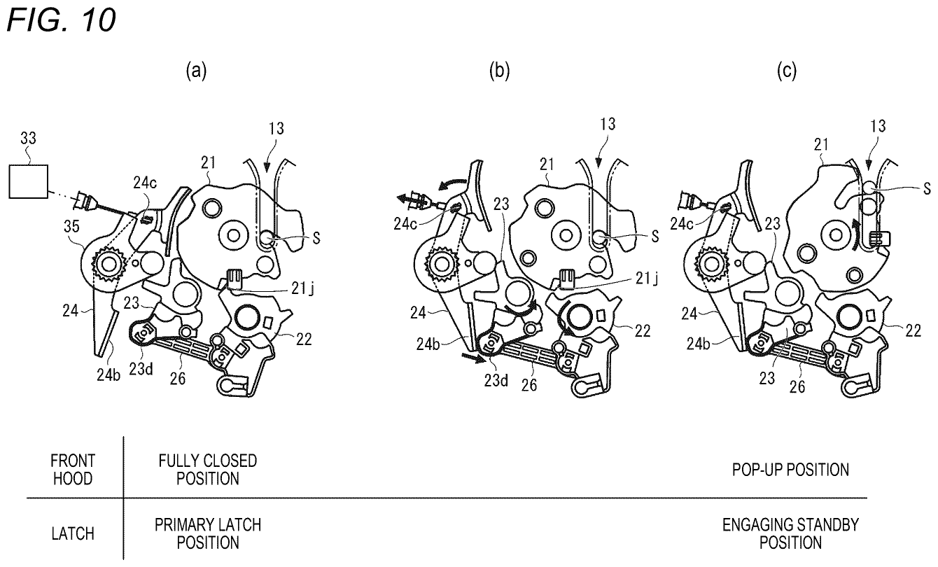

(a) to (c) of FIG. 10 are diagrams sequentially showing the operation of the latch device 1 when the operation force input to the in-vehicle-cabin operation portion 33 is transmitted to the emergency lever 24. Although details will be described later, the operation of the latch device 1 when the operation force input to the in-frunk operation portion 31 is transmitted to the emergency lever 24 via a first transmission path 31A is also similar to that shown in (a) to (c) of FIG. 10.

As shown in (a) and (b) of FIG. 10, when the in-vehicle-cabin operation portion 33 is operated with the latch 21 at the primary latch position, the operation force rotates the emergency lever 24 counterclockwise. As the emergency lever 24 continues to rotate, the pawl pressing portion 24b abuts against the lever link portion 23d of the secondary pawl 23, and causes the primary pawl 22 to rotate via the secondary pawl 23 and the link bar 26 in the direction to release the meshing state with the latch 21. Accordingly, as shown in (c) of FIG. 10, the meshing state between the secondary pawl 23 and the latch 21 and the meshing state between the primary pawl 22 and the latch 21 are released, and the latch 21 rotates in the release direction to return to the engaging standby position. Then, the front hood FP moves to the pop-up position where a person can move the front hood FP to the fully open position.

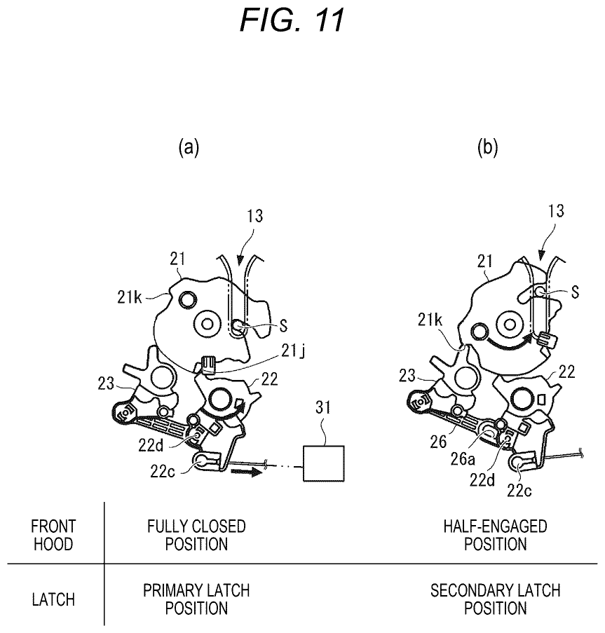

(a) and (b) of FIG. 11 are diagrams sequentially showing the operation of the latch device 1 when the operation force input to the in-frunk operation portion 31 is transmitted to the primary pawl 22.

As shown in (a) and (b) of FIG. 11, when the in-frunk operation portion 31 is operated from a state where the latch 21 is at the primary latch position, the operation force is transmitted to the frunk cable connection portion 22c of the primary pawl 22, and the primary pawl 22 rotates in the direction to release the meshing state with the latch 21. In this case, the lever link portion 22d of the primary pawl 22 moves along the long hole 26a, so that the link bar 26 does not interlock with the secondary pawl 23, and thus the primary pawl 22 rotates independently of the secondary pawl 23, while the secondary pawl 23 remains in the meshing state with the latch 21. Accordingly, only the meshing state between the latch 21 and the primary pawl 22 is released, and the latch 21 is at the secondary latch position where the latch 21 engages with the secondary pawl 23, that is, the front hood FP is at the half-engaged position.

### [Front Trunk System]

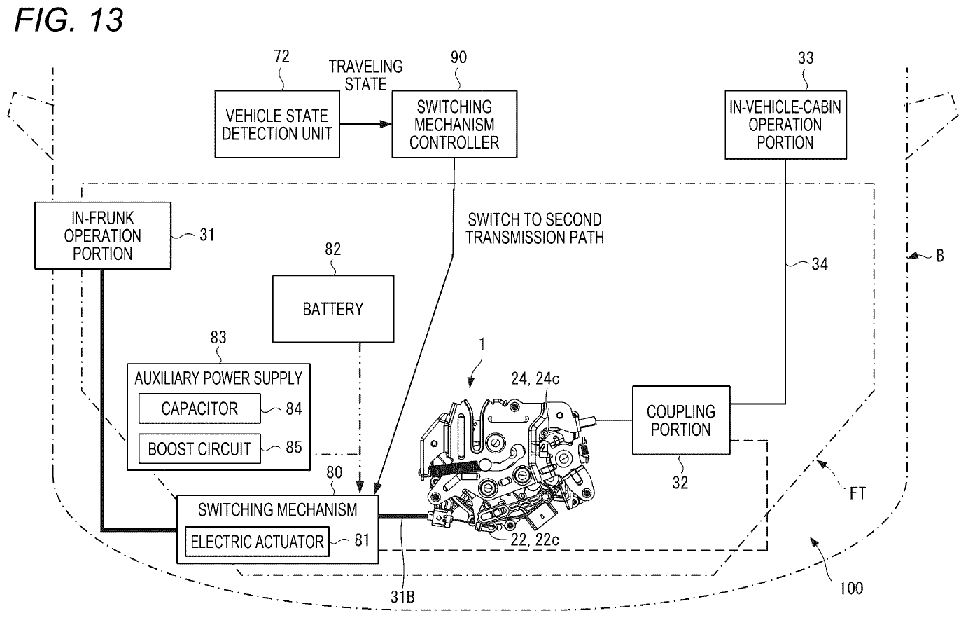

FIGS. 12 and 13 are schematic diagrams showing an embodiment of the front trunk system 100 of the present disclosure. The front trunk system 100 includes the latch device 1, the in-frunk operation portion 31, a switching mechanism 80, and a switching mechanism controller 90.

The switching mechanism controller 90 is a processing device such as a CPU, and controls an operation of the switching mechanism 80 based on the state of the vehicle determined from the detection result of the vehicle state detection unit 72. The switching mechanism controller 90 may be implemented, for example, by causing a processing device such as a CPU to execute a program, that is, implemented by software, by hardware such as an IC, or by a combination of software and hardware. The switching mechanism controller 90 and the latch device controller 70 may be configured as the same controller.

The switching mechanism 80 switches an operation mode of the latch device 1 when the in-frunk operation portion 31 is operated. Specifically, the switching mechanism 80 switches between a mode in which both the meshing state between the primary pawl 22 and the latch 21 and the meshing state between the secondary pawl 23 and the latch 21 are released when the in-frunk operation portion 31 is operated, and a mode in which only the meshing state between the primary pawl 22 and the latch 21 is released when the in-frunk operation portion 31 is operated.

In more detail, based on the state of the vehicle determined from the detection result of the vehicle state detection unit 72, the switching mechanism 80 selectively switches, to the first transmission path 31A or a second transmission path 31B, a transmission path through which the operation force input to the in-frunk operation portion 31 is transmitted to the latch device 1.

As shown by thick solid lines in FIG. 12, the first transmission path 31A is a path that connects the in-frunk operation portion 31 and the cable connection portion 24c provided on the emergency lever 24 of the latch device 1, and is implemented by a plurality of cables or the like. When the first transmission path 31A is set, if the in-frunk operation portion 31 is operated with the front hood FP at the fully closed position, the operation force is transmitted to the emergency lever 24 via the first transmission path 31A, and the meshing state between the latch 21 and the primary pawl 22 and the meshing state between the latch 21 and the secondary pawl 23 are released (see (a) to (c) of FIG. 10). That is, the front hood FP moves to the pop-up position by the operation of the in-frunk operation portion 31.

As described above, in addition to the operation force input to the in-frunk operation portion 31, the operation force input to the in-vehicle-cabin operation portion 33 is also transmitted to the cable connection portion 24c of the emergency lever 24, and thus the first transmission path 31A and the vehicle cabin side transmission path 34 are connected to the cable connection portion 24c via a coupling portion 32. The coupling portion 32 is, for example, a bell crank, and a cable constituting the vehicle cabin side transmission path 34 and a cable constituting the first transmission path 31A are coupled. The first transmission path 31A includes, for example, a cable connecting the in-frunk operation portion 31 and the switching mechanism 80, a cable connecting the switching mechanism 80 and the coupling portion 32, and a cable connecting the coupling portion 32 and the cable connection portion 24c. Note that when an operation force is input to the bell crank from either the vehicle cabin side transmission path 34 or the first transmission path 31A, the operation force is not transmitted to the other one. However, the configuration of the first transmission path 31A is not limited thereto, and any configuration can be adopted as long as the operation force input to the in-frunk operation portion 31 can be transmitted to the cable connection portion 24c of the emergency lever 24.

As shown by thick solid lines in FIG. 13, the second transmission path 31B is a path that connects the in-frunk operation portion 31 and the frunk cable connection portion 22c provided at the primary pawl 22 of the latch device 1, and is implemented by a plurality of cables or the like. When the transmission path is set as the second transmission path 31B, if the in-frunk operation portion 31 is operated with the front hood FP at the fully closed position, the operation force is transmitted to the primary pawl 22 via the second transmission path 31B, and only the meshing state between the latch 21 and the primary pawl 22 is released (see (a) and (b) of FIG. 11). That is, the front hood FP is at the half-engaged position by the operation of the in-frunk operation portion 31.

The second transmission path 31B includes, for example, a cable connecting the in-frunk operation portion 31 and the switching mechanism 80, and a cable connecting the switching mechanism 80 and the frunk cable connection portion 22c. However, the configuration of the second transmission path 31B is not limited thereto, and any configuration can be adopted as long as the operation force input to the in-frunk operation portion 31 can be transmitted to the frunk cable connection portion 22c.

The switching mechanism 80 selectively switches the transmission path of the operation force to the first transmission path 31A or the second transmission path 31B based on the state of the vehicle, whether the vehicle is in the first state mainly including the stopped state where the vehicle is stopped, or a second state mainly including a traveling state where the vehicle is traveling.

The first state includes, for example, a stopped state where the vehicle is completely stopped, a traveling state at a low speed (for example, traveling at 5 km/h or lower), and a state where a P (parking) range is selected. The second state includes, for example, a traveling state where the vehicle is traveling at a predetermined speed or higher (for example, 5 km/h or higher), and a state where a gear position other than the P range is selected.

In the present embodiment, when the vehicle is in the first state, the switching mechanism 80 connects the in-frunk operation portion 31 and the latch device 1 via the first transmission path 31A, and can release the meshing state between the latch 21 and the primary pawl 22 and the meshing state between the latch 21 and the secondary pawl 23 by the operation force input to the in-frunk operation portion 31. On the other hand, when the vehicle is in the second state, the switching mechanism 80 connects the in-frunk operation portion 31 and the latch device 1 via the second transmission path 31B, and can release the meshing state between the latch 21 and the primary pawl 22 by the operation force input to the in-frunk operation portion 31.

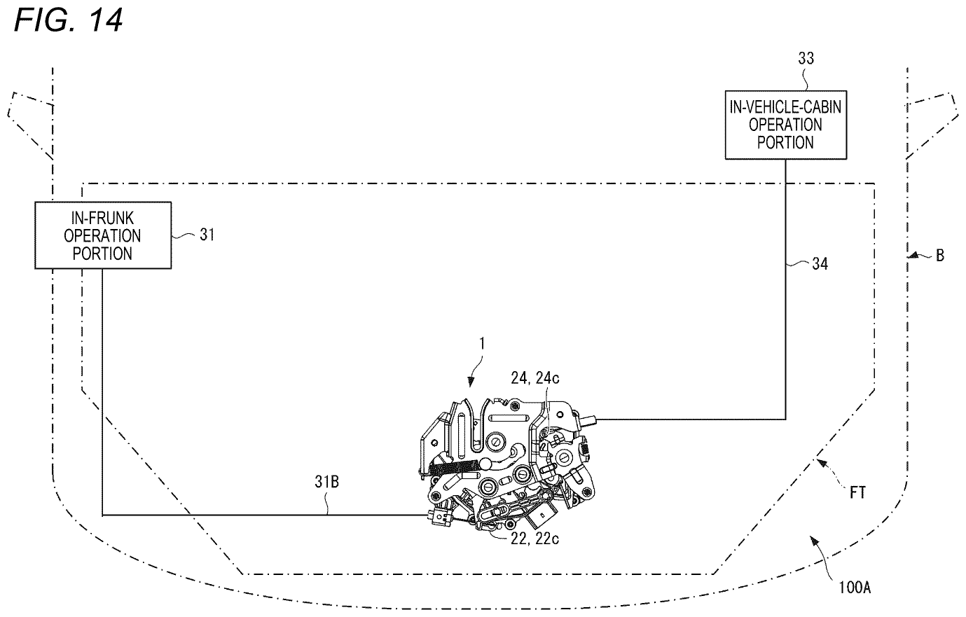

In a case of a front trunk system 100A in which the switching mechanism 80 is not provided and the in-frunk operation portion 31 and the frunk cable connection portion 22c of the primary pawl 22 are connected by the cable (see FIG. 14), in the operation of the in-frunk operation portion 31, the front hood FP does not move to the pop-up position where the front hood FP can be fully opened, regardless of the state of the vehicle. According to such a configuration, if a person trapped in the frunk FT operates the in-frunk operation portion 31, the front hood FP does not move to the fully open position during the traveling, and thus the safety is ensured in terms of the traveling, but the front hood FP does not move to the pop-up position even when the vehicle is stopped. Accordingly, a person trapped in the frunk FT can call for help from the outside from the inside of the frunk FT where the front hood FP is at the half-engaged position, but cannot escape by himself/herself.

Since the front trunk system 100 of the present embodiment includes the switching mechanism 80, the transmission path of the operation force input to the in-frunk operation portion 31 can be selectively switched to the first transmission path 31A or the second transmission path 31B based on the state of the vehicle. When the vehicle is in the first state (stopped state or the like), the front hood FP can be moved by the operation force of the in-frunk operation portion 31 from the fully closed position to the pop-up position where a person can operate the front hood FP to the fully open position, and thus even if a person is trapped in the frunk FT, the person can escape from the frunk FT by operating the in-frunk operation portion 31, and the safety against being trapped in the frunk FT is sufficiently ensured. When the vehicle is in the second state (traveling state or the like), the front hood FP is not moved to the pop-up position where the front hood FP can be operated to the fully open position by the operation of the in-frunk operation portion 31, and thus there is no risk of the front hood FP suddenly moving to the fully open position during the traveling, and the safety is ensured.

The in-frunk operation portion 31 is configured such that the operation force is mechanically transmitted to the latch device 1 as a pulling force via the cable, and thus the front hood FP can be opened even if the battery runs out of power, unlike a configuration in which the meshing state between the primary pawl 22 and the latch 21 and the meshing state between the secondary pawl 23 and the latch 21 are released by drive of a motor or the like. Accordingly, reliability of the front trunk system 100 can be improved.

The latch device 1 applied to the front trunk system 100 provided with the switching mechanism 80 and the latch device 1 applied to the front trunk system 100A not provided with the switching mechanism 80 can be the same. Accordingly, when changing from the front trunk system 100A to the front trunk system 100, selective switching between the first transmission path 31A and the second transmission path 31B can be performed by providing the switching mechanism 80 without significantly changing the latch device 1 of the front trunk system 100A. Accordingly, the structure of the front trunk system 100 can be prevented from becoming complicated.

The switching mechanism controller 90 determines whether the vehicle is in the second state based on the speed and/or the gear position of the vehicle. Based on such information, the switching mechanism controller 90 can appropriately determine whether the vehicle is in the traveling state or in a travelable state (that is, second state).

The switching mechanism 80 includes an electric actuator 81 (for example, electric motor) that can be operated by power from a battery 82 mounted on the vehicle. The electric actuator 81 performs drive based on a command from the switching mechanism controller 90, and selectively switches the transmission path of the operation force to the first transmission path 31A or the second transmission path 31B. The battery 82 is a low-voltage battery that can output a low voltage of about 12V, and supplies power to cause auxiliary equipment of the vehicle to operate.

When the transmission path is set as the first transmission path 31A, the electric actuator 81 drives to couple, for example, the cable connecting the in-frunk operation portion 31 and the switching mechanism 80 and the cable connecting the switching mechanism 80 and the coupling portion 32. When the transmission path is set as the second transmission path 31B, the electric actuator 81 drives to couple the cable connecting the in-frunk operation portion 31 and the switching mechanism 80 and the cable connecting the switching mechanism 80 and the frunk cable connection portion 22c.

The front trunk system 100 further includes an auxiliary power supply 83 that can supply power to the electric actuator 81. The auxiliary power supply 83 stores power by power from the battery 82, and when the battery 82 runs out of power (for example, when the voltage of the battery 82 is 6V or less), supplies power to the electric actuator 81 instead of the battery 82. Accordingly, the switching mechanism 80 can switch to an appropriate transmission path based on the state of the vehicle even when the battery 82 runs out of power, and the reliability of the front trunk system 100 can be further improved. In particular, even when the battery 82 runs out of power and a person is trapped in the frunk FT, the person can escape from the frunk FT by the operation of the in-frunk operation portion 31.

The auxiliary power supply 83 has a capacitor 84 that can store power by power from the battery 82, and a boost circuit 85 that boosts power supplied from the capacitor 84 to the electric actuator 81. The capacitor 84 has a longer life than that of the battery 82 and can be charged and discharged over a long period of time. The capacitor 84 is, for example, an electric double layer capacitor. By providing the capacitor 84, it is possible to maintain a function as an auxiliary power supply for the electric actuator 81 over a long period of time.

The boost circuit 85 has a boost coil and a switching element (not shown), and is provided in an output path of the capacitor 84. By providing the boost circuit 85, it is possible to compensate for a voltage drop of the capacitor 84 during discharge and cause the electric actuator 81 to operate with a stable voltage, and thus it is possible to further improve the reliability of the front trunk system 100.

Here, regarding the disposing of the switching mechanism 80, the switching mechanism 80 is preferably disposed independently of the latch device 1, in other words, disposed as a separate component from the latch device 1. According to such a configuration, the switching mechanism 80 can be relatively easily provided in the front trunk system 100A that does not have the switching mechanism 80, and thus the front trunk system 100A can be easily changed to the front trunk system 100 of the present embodiment to which a function for selecting the transmission path of the operation force is added.

Regarding the disposing of the auxiliary power supply 83, the auxiliary power supply 83 is preferably disposed near the latch device 1 or the switching mechanism 80. A term “disposed near” includes a configuration in which the auxiliary power supply 83 and the latch device 1 or the switching mechanism 80 are disposed integrally. According to such a configuration, a wiring between the auxiliary power supply 83 and the switching mechanism 80 can be shortened or eliminated, and the likelihood of a disconnection occurring, for example, during a vehicle collision can be reduced. Accordingly, the stability of the power supply to the switching mechanism 80 is increased, and the reliability of the system is improved.

Although an embodiment of the present disclosure has been described above with reference to the accompanying drawings, it is needless to say that the present disclosure is not limited to the embodiment. It is apparent to those skilled in the art that various modifications or corrections can be conceived within the scope described in the claims, and it is understood that the modifications or corrections naturally fall within the technical scope of the present disclosure. Components in the above embodiments may be freely combined without departing from the gist of the disclosure.

The present specification describes at least the following matters. Corresponding components and the like in the above-described embodiments are described in parentheses as an example, and the present disclosure is not limited thereto.

(1) A front trunk system (front trunk system 100), including:
a latch device (latch device 1) configured to engage with a striker (striker S) provided at a front hood (front hood FP) for covering a front trunk (frunk FT) of a vehicle;
an operation portion (in-frunk operation portion 31) provided in the front trunk and configured to transmit an operation force input thereto to the latch device via a first transmission path (first transmission path 31A) or a second transmission path (second transmission path 31B); and
a switching mechanism (switching mechanism 80) configured to switch paths for transmitting the operation force input to the operation portion to the latch device based on a state of the vehicle, in which
the latch device includes:
   a latch (latch 21) configured to engage with the striker when the front hood is in a closed state and be biased by a biasing member (latch spring 21e) in a direction to disengage from the striker;
   a primary pawl (primary pawl 22) configured to mesh with the latch when the latch engaging with the striker is disposed at a predetermined primary latch position to maintain the front hood at a fully closed position; and
   a secondary pawl (secondary pawl 23) configured to mesh with the latch when the latch released from a meshing state with the primary pawl is disposed at a predetermined secondary latch position to maintain the front hood at a half-engaged position,
when the vehicle is in a first state including a stopped state, the switching mechanism connects the operation portion and the latch device via the first transmission path, allowing the meshing state between the latch and the primary pawl and a meshing state between the latch and the secondary pawl to be released by the operation force input to the operation portion, and
when the vehicle is in a second state including a traveling state, the switching mechanism connects the operation portion and the latch device via the second transmission path, allowing the meshing state between the latch and the primary pawl to be released by the operation force input to the operation portion.

According to (1), the operation portion which transmits the operation force input thereto to the latch device is provided inside the front trunk, and the operation force is transmitted to the latch device via the first transmission path or the second transmission path that is selectively switched based on the state of the vehicle, and thus reliability of the front trunk system regarding opening of the front hood can be improved. Since the selective switching between the first transmission path and the second transmission path is implemented by providing the switching mechanism, the structure of the latch device can be prevented from becoming complicated.

When the state is the first state including the stopped state, the front hood is at a fully open position by the operation of the operation portion, and thus even if a person is trapped in the front trunk, the person can escape from the front trunk by the operation of the operation portion, and safety is ensured. When the state is the second state including the traveling state, the front hood is not at a position where the front hood can be fully opened by the operation of the operation portion, but is at the half-engaged position, and thus the safety during the traveling is ensured.

(2) The front trunk system according to (1), in which
the second state includes at least one of a state where a speed of the vehicle is equal to or greater than a predetermined value or a state where a gear position of the vehicle is other than a parking range.

According to (2), the second state of the vehicle is determined based on the speed and/or the gear position of the vehicle, and thus the switching of the transmission path can be appropriately determined by the switching mechanism.

(3) The front trunk system according to (1) or (2), further including:
an auxiliary power supply (auxiliary power supply 83), in which
the switching mechanism includes an electric actuator (electric actuator 81) configured to operate with power from a battery (battery 82) mounted on the vehicle or the auxiliary power supply.

According to (3), the auxiliary power supply capable of supplying power to the switching mechanism is provided, even when the battery runs out of power, the transmission path of the operation force can be appropriately switched based on the state of the vehicle, and reliability of the system can be further improved.

(4) The front trunk system according to (3), in which
the auxiliary power supply includes a capacitor (capacitor 84) configured to be charged with power from the battery, and a boost circuit (boost circuit 85) configured to boost power supplied from the capacitor to the electric actuator.

According to (4), by using the capacitor, which has a longer life than that of the battery, as the auxiliary power supply, it is possible to maintain a function as the auxiliary power supply for the electric actuator for a long period of time. By providing the boost circuit, the switching mechanism can be operated at a stable voltage, and thus the reliability of the system can be further improved.

(5) The front trunk system according to any one of (1) to (4), in which
the switching mechanism is disposed apart from the latch device.

According to (5), the switching mechanism can be relatively easily provided in the system in which the latch device and the operation portion are connected without the switching mechanism, and thus the system can be easily modified to a system that is added a function for selecting the transmission path of the operation force.

(6) The front trunk system according to (3) or (4), in which
the switching mechanism is disposed apart from the latch device, and
the auxiliary power supply is disposed near the latch device or the switching mechanism.

According to (6), a wiring between the auxiliary power supply and the switching mechanism can be shortened or eliminated, and thus the likelihood of a disconnection occurring, for example, during a vehicle collision can be reduced. Accordingly, certainty of the power supply to the switching mechanism is increased, and the reliability of the system is improved.

What is claimed is:

1. A front trunk system, comprising:
a latch device configured to engage with a striker provided at a front hood for covering a front trunk of a vehicle;
an operation portion provided in the front trunk and configured to transmit an operation force input thereto to the latch device via a first transmission path or a second transmission path; and
a switching mechanism configured to switch paths for transmitting the operation force input to the operation portion to the latch device based on a state of the vehicle, wherein
the latch device includes:
a latch configured to engage with the striker when the front hood is in a closed state and be biased by a biasing member in a direction to disengage from the striker;
a primary pawl configured to mesh with the latch when the latch engaging with the striker is disposed at a predetermined primary latch position to maintain the front hood at a fully closed position; and
a secondary pawl configured to mesh with the latch when the latch released from a meshing state with the primary pawl is disposed at a predetermined secondary latch position to maintain the front hood at a half-engaged position,
when the vehicle is in a first state including a stopped state, the switching mechanism connects the operation portion and the latch device via the first transmission path, allowing the meshing state between the latch and the primary pawl and a meshing state between the latch and the secondary pawl to be released by the operation force input to the operation portion, and
when the vehicle is in a second state including a traveling state, the switching mechanism connects the operation portion and the latch device via the second transmission path, allowing the meshing state between the latch and the primary pawl to be released by the operation force input to the operation portion.

2. The front trunk system according to claim 1, wherein
the second state includes at least one of a state where a speed of the vehicle is equal to or greater than a predetermined value or a state where a gear position of the vehicle is other than a parking range.

3. The front trunk system according to claim 1, further comprising:
an auxiliary power supply, wherein
the switching mechanism includes an electric actuator configured to operate with power from a battery mounted on the vehicle or the auxiliary power supply.

4. The front trunk system according to claim 3, wherein
the auxiliary power supply includes a capacitor configured to be charged with power from the battery, and a boost circuit configured to boost power supplied from the capacitor to the electric actuator.

5. The front trunk system according to claim 1, wherein
the switching mechanism is disposed apart from the latch device.

6. The front trunk system according to claim 3, wherein
the switching mechanism is disposed apart from the latch device, and
the auxiliary power supply is disposed near the latch device or the switching mechanism.
